(19) United States
(12) Patent Application Publication
(10) Pub. No.: US 2009/0241786 A1
(43) Pub. Date: Oct. 1, 2009

(54) Device for performing the wetting operation for offset printing

(75) Inventor: Gerardo Antonio Romero Salvo, Barcelona (ES)

Correspondence Address: SUGHRUE MION, PLLC, 2100 PENNSYLVANIA AVENUE, N.W., SUITE 800, WASHINGTON, DC, 20037, US

(73) Assignee: DELTA GRAF, S.A., Barcelona (ES)

(21) Appl. No.: 11/887,097

(22) PCT Filed: Jun. 29, 2005
(86) PCT No.: PCT/EP2005/006968

§ 371 Date: Sep. 25, 2007

(30) Foreign Application Priority Data
Apr. 12, 2005 (ES) U 200500822

(51) Int. Cl. B41F 7/02

(52) U.S. Cl. 101/147

(57) ABSTRACT

Device for performing the wetting operation for offset printing, comprising a main receptacle (1) which contains a wetting solution; an outlet pipe (2) with a pump (3) which pushes the solution towards an outlet nozzle (4) to project it inside a recipient (5) housed in the main receptacle; a feed pipe (6) which joins said recipient to the wetting system of the offset printing machine; and a pipe (8) through which the wetting solution returns to the main receptacle. The outlet pipe of the solution has a Venturi device (9) whose main pipe (14), through which the wetting solution passes, forms part of said outlet pipe and has at least one side air-intake pipe (10) joining the main pipe at an oblique angle.

### TECHNICAL FIELD OF THE INVENTION

The present invention relates to a device for performing the wetting operation for offset printing, especially for improving its yield.

### BACKGROUND OF THE INVENTION

Offset printing is a method for indirect printing based on physical and chemical surface phenomena, and is not therefore a system based on relief such as typography, flexography, pad printing etc., i.e., it is a planographic system wherein the phase before applying the ink to the paper consists in the chemical attraction and repulsion between different lipophile and hydrophile substances. With the aim of obtaining satisfactory results, both the ink and the water must possess the physical and chemical characteristics suitable to ensure that the process is the correct one.

The wetting solution most used essentially comprises water. In this way, and taking account of the fact that the water used by offset machinery is normal mains water, certain special additives must be included to give it specific properties.

The use of isopropyl alcohol in the wetting solution provides an interfacial tension between the solution and the ink which produces less emulsifying of the solution in the ink, which is why the ink printed on the paper is saturated better than any other wetting system. Like other added advantages, the wetting system using isopropyl alcohol provides greater viscosity which enables a more uniform transfer of the image and quicker drying.

Regardless of the advantages of using isopropyl alcohol in the solution used in offset printing systems, the possible toxicity that systems based on isopropyl alcohol can present have been assessed for some years now. In addition to toxicity, these systems are difficult and dangerous to store because of their inflammability.

Consequently, there is a general tendency to eliminate this product and restrict is use and, in some countries, its use is in the process of being permanently prohibited.

A wide variety of devices are currently know for the wetting operation used in offset printing, which have unsuccessfully tried to formulate additives which satisfy the requirements for quality mentioned and which completely dispense with isopropyl alcohol.

The basic reason for these failed attempts is that the need to have to reduce surface tension to prevent the water-ink emulsifying to levels comparable to the water-alcohol system requires the use of group III surfactant agents. A high concentration of these surfactant agents causes a reduction in the interface by an affinity between the fatty acids in the ink and the hydrocarbon chains of the surfactant agents. The surfactant agents produce a high level of foam and, although are not volatile, remain in the ink rollers and accumulate causing operating problems.

The impossibility of forming stable colloids using other substances which reduce surface tension and maintain a better solution-ink interface, together with the problem described above, are the main reasons for which it has proved impossible to replace isopropyl alcohol.

In this way, devices are known which have caused a U-turn in what is referred to as the composition of the wetting solution, moving on to configure a device which is based on oxygenation of the solution.

Such devices comprise a main receptacle which contains a wetting solution, an outlet pipe with a pump which pushes the solution towards an outlet nozzle to project it inside a recipient housed inside the main receptacle, a feed pipe which joins said recipient with the wetting system of the offset printing machine and a pipe through which the wetting solution returns to the main receptacle.

Patent No. ES9902829, “Wetting solution for offset printing plates and procedure and device for its preparation”, discloses a device with a helicoidal pipe where, in the oxygen adsorption stage, jets of reticulated fractions of the solution are projected onto the free surface of the solution itself, which pass through the pipe at high speed and form an outlet cone, with a solid 90° angle, on a deflecting surface and against the free surface of the wetting solution obtaining a constant adsorption isotherm on its free surface.

One drawback associated with this device is that the levels of adsorption are not very high. Similarly, this value also depends on the pressure at which the solution is pushed. This implies that it must have a high-powered pumping system. To summarize, the system entails a high cost with the need for high-performance components.

Another drawback of these devices is that the distance between the end of the nozzle and the surface of the liquid is considerable, i.e. a certain amount of clearance is needed for the liquid coming out of the nozzle to hit the surface of the solution in order for air adsorption to take place.

### EXPLANATION OF THE INVENTION

The device for carrying out the wetting operation for offset printing in accordance with the invention improves the wetting process and eliminates almost all the drawbacks mentioned. Said device comprises a main receptacle which contains a wetting solution, an outlet pipe with a pump which pushes the solution towards an outlet nozzle to project it inside a recipient housed in the main receptacle; a feed pipe which joins said recipient to the wetting system of the offset printing machine and a pipe through which the wetting solution returns to the main receptacle.

The device of the invention is essentially characterized in that the outlet pipe of the solution has a Venturi device whose main pipe, through which the wetting solution passes, forms part of said outlet pipe and has at least one side air-intake pipe, joining the main pipe at an oblique angle.

In a preferred form, the Venturi device, in particular, has three identical side air-intake pipes, inclining at the same angle with respect to the main pipe through which the wetting solution passes and are positioned at equal distances from one another.

In accordance with another characteristic of the invention, in the Venturi device, the sum of the sections of all the orifices connecting the side air-intake pipes is approximately equal to the section of the main pipe through which the wetting solution passes.

### BRIEF DESCRIPTION OF THE DRAWINGS

In the attached drawings is an illustration of a form of embodiment of the device. In said drawings:

FIG. 1 is a diagrammatic view of all the components;

FIG. 2 is a detailed view of the Venturi device; and

FIG. 3 is a cutaway view of the device with the three side pipes of the Venturi device.

### DETAILED DESCRIPTION OF THE DRAWINGS

The device for embodiment of the wetting operation for offset printing according to the invention comprises a main container receptacle 1 which holds the wetting solution for the wetting cylinder of an offset printing machine like the one seen in FIG. 1.

The device according to the invention has an outlet pipe 2, with a first pump 3 which pushes the solution towards an outlet nozzle 4 to project the solution inside the recipient 5 housed in the main receptacle 1.

The recipient 5 is joined, via a feed pipe 6 which connects it in its lower part, to the wetting trough 11 of the moisturizing cylinder of the offset printing machine. Said wetting trough 11 has a return pipe 12 for the wetting solution passing from the wetting trough 11 to the main container receptacle 1. The fraction of the wetting solution which goes from the recipient 5 to the wetting trough 11 is pushed by a second feed pump 7. The return pipe 12 has a third pump 13, to push the remaining fraction of the wetting solution which has not been incorporated in the printing plate.

The outlet pipe 2 has a Venturi device 9 whose main pipe, through which the wetting solution passes, forms part of said outlet pipe 2.

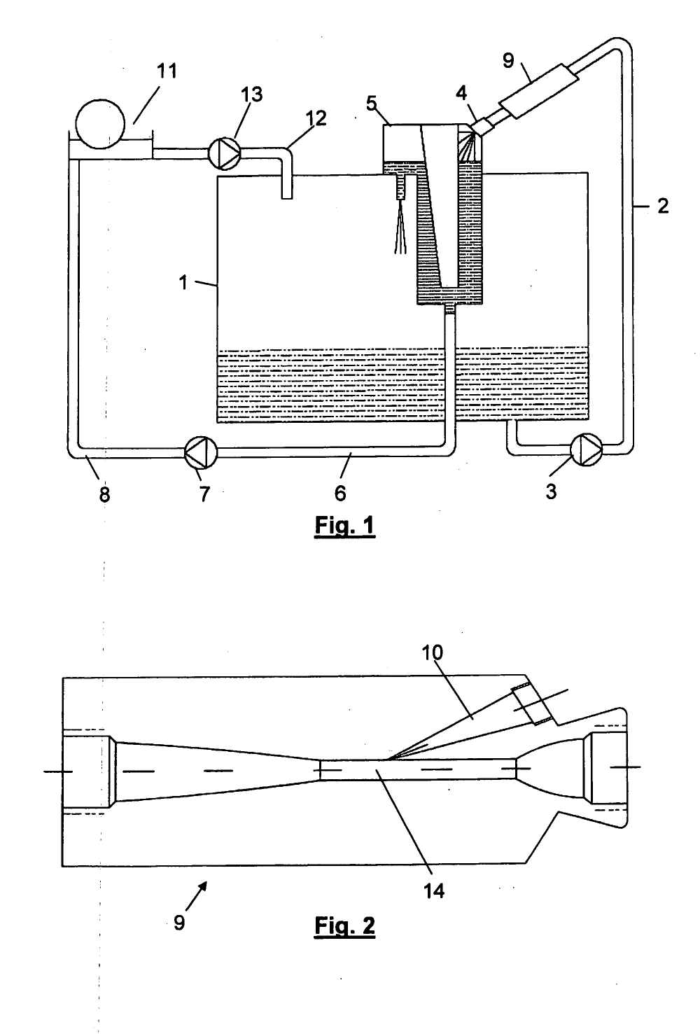

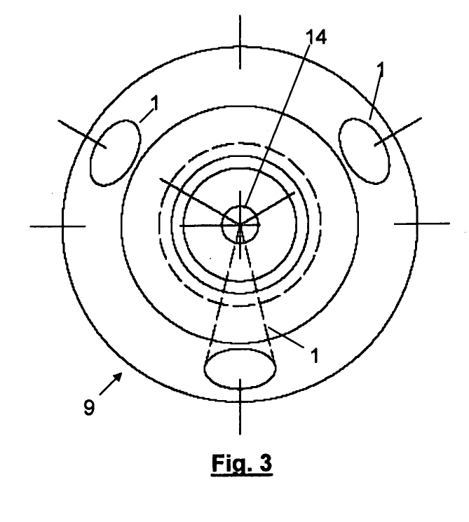

According to a preferred embodiment, the Venturi device 9 comprises at least one side air-intake pipe 10, which joins the main pipe 14 through which the wetting solution passes, at an oblique angle, as shown in FIG. 2.

In a preferred embodiment, as shown in FIG. 3, the Venturi device 9 has three identical side air-intake pipes 10, which are inclined in the same way with respect to the main pipe 14 through which the wetting solution passes and are at equal distances from one another. The sum of the sections of all the orifices connecting the side air-intake pipes 10 is approximately equal to the section of the main pipe 14 through which the wetting solution passes. The outlet flow of the wetting solution is determined by the machine's need to be fed.

The devices currently known involve forcing the solution to pass through the nozzle at high pressure and to hit the surface of the liquid contained in the recipient 5 and the special internal structure of the cylinder to produce the isotherm.

Unlike what is already known, the Venturi device 9 helps to increase the amount of air that enters the nozzle mixed with solution whereby, in this way, what is achieved is that when the wetting solution mixed with more air entering the nozzle and passing through it, the adsorption produced in the isotherm generated is much greater than in normal conditions. In this way, a better effect is achieved by introducing air to the wetting solution before it enters the nozzle and also there is no need for heavy work by the pump to produce high pressure.

The Venturi device 9 makes use of the Williams Henry law, which states that the quantity of air mixed with the wetting solution is directly proportionate to atmospheric pressure.

Similarly, on making the wetting solution pass through the Venturi device 9 at high speed, great depression is produced in the side pipes 10, thus forcing the air to enter towards the solution and to mix with it, attaining truly high adsorption values.

In this case, the distance between the end of the nozzle and the surface of the liquid is not representative, since the adsorption of the air is generated in the centre of the Venturi 9 and no determined distance is needed for the wetting solution to hit the surface of the liquid contained in the recipient 5, as is the case in the devices known at present.

With this device, the oxygen adsorption values can be increased by more than 50%, up to values of around 160 ppm.

1. A device for performing the wetting operation for offset printing, comprising a main receptacle (1) which contains a wetting solution; an outlet pipe (2) with a pump (3) which pushes the solution towards an outlet nozzle (4) to project it inside a recipient (5) housed in the main receptacle; a feed pipe (6) which joins said recipient to the wetting system of the offset printing machine; and a pipe (8) through which the wetting solution returns to the main receptacle, wherein the outlet pipe of the solution has a Venturi device (9) whose main pipe (14), through which the wetting solution passes, forms part of the aforementioned outlet pipe, and has at least one side air-intake pipe (10), which joins the main pipe at an oblique angle.

2. The device according to claim 1, wherein the Venturi device (9) has three identical side air-intake pipes (10), which are inclined in the same way with respect to the main pipe (14) through which the wetting solution passes and are positioned at equal distances from one another.

3. The device according to claim 1, wherein the Venturi device the sum of the sections of all the orifices connecting the side air-intake pipes (10) is approximately equal to the section of the main pipe (14) through which the wetting solution passes.

4. The device according to claim 2, wherein the Venturi device the sum of the sections of all the orifices connecting the side air-intake pipes (10) is approximately equal to the section of the main pipe (14) through which the wetting solution passes.
